(19) United States
(12) Patent Application Publication
(10) Pub. No.: US 2018/0073692 A1
(43) Pub. Date: Mar. 15, 2018

(54) SYSTEM AND METHOD FOR PREVENTING LIGHT SPILL

(71) Applicants: Pavel JURIK, Postredni Becva (CZ); Josef VALCHAR, Postredni Becva (CZ)

(72) Inventors: Pavel JURIK, Postredni Becva (CZ); Josef VALCHAR, Postredni Becva (CZ)

(21) Appl. No.: 15/264,620

(22) Filed: Sep. 14, 2016

(51) Int. Cl. F21S 2/00; F21V 11/08; F21V 5/04; F21V 5/00

(52) U.S. Cl. CPC F21S 2/005; F21V 11/08; F21Y 2115/10; F21V 5/007; F21V 5/04

(57) ABSTRACT

Described is a light engine comprised of an array of light engine modules which are compartmentalized to minimize light spill from one light engine module to other light engine modules.

### TECHNICAL FIELD OF THE INVENTION

The present invention generally relates to a method for providing a luminaire, specifically to optical systems and a method for preventing light spill between adjacent light sources within the luminaire.

### Background of the Invention

Luminaires with automated and remotely controllable functionality are well known in the entertainment and architectural lighting markets. Such products are commonly used in theatres, television studios, concerts, theme parks, night clubs and other venues. A typical product will provide control over the functions of the luminaire allowing the operator to control the intensity and color of the light beam from the luminaire that is shining on the stage or in the studio. Many products also provide control over other parameters such as the position, focus, beam size, beam shape and beam pattern. In such products that contain light emitting diodes (LEDs) to produce the light output it is common to use more than one color of LEDs and to be able to adjust the intensity of each color separately such that the output, which comprises the combined mixed output of all LEDs, can be adjusted in color. For example, such a product may use red, green, blue, and white LEDs with separate intensity controls for each of the four types of LED. This allows the user to mix almost limitless combinations and to produce nearly any color they desire.

FIG. 1 illustrates a typical multiparameter automated luminaire system 10. These systems typically include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. The luminaire system 10 is typically controlled by an operator through the control desk 15.

Luminaires have been provided using non-LED light sources designed to produce a single narrow beam or a plurality of such beams. Such luminaires may use low etendue, HID light sources with a small arc gap in order to facilitate the production of tight, almost parallel light beams. U.S. patent application Ser. Nos. 14/042,758 and 14/042,759 provide examples of such a system. Single and multi-color LED sourced luminaires have also been produced with narrow beam capability using sophisticated collimation systems as, for example, disclosed in U.S. patent application Ser. No. 14/405,355. LEDs however are high etendue light sources by comparison with HID and it is difficult to produce multiple separated beam systems using LED light sources.

Prior art optical systems utilizing multiple LED emitters designed to be run independently as separate light modules within a single luminaire frequently suffer from light spill from one light module to the adjacent light module. This light spill contaminates the effect and clarity of each of the independent light modules and reduces the effectiveness of the luminaire for both the user and the viewer. Independent light modules should, be truly independent with minimal spill of light from one light module to adjacent light module(s). Prior art systems may use internal baffles or egg-crates to try and isolate the independent light sources, but still suffer from light sill or bleeding across adjacent light modules due to internal reflection, back reflection, refraction, or other light leakage path(s). These prior art systems may also reduce the performance of the luminaire by restricting the output apertures in an attempt to provide light isolation.

There is a need for a method for producing and controlling the light spill between adjacent modules from an LED sourced wash light luminaire producing multiple light beams.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a multiparameter automated luminaire lighting system including luminaires as further described herein;

FIG. 2 illustrates the layout of an embodiment of the rear portion of a light engine of a luminaire generating multiple beam effects;

FIG. 3 illustrates an embodiment of the light engine illustrated in FIG. 2 fitted with a first light shield;

FIG. 4 illustrates an embodiment of a first baffle, lenses, and a second baffle of the light output portion of a luminaire generating multiple beam effects;

FIG. 5 illustrates a further view of an embodiment of the lenses;

FIG. 6 illustrates an exploded front angled view of the light engine and light spill prevention system of an embodiment of a luminaire generating multiple beam effects;

FIG. 7 illustrates a further exploded back angled view of the light engine and light spill prevention system of an embodiment of a luminaire generating multiple beam effects; and;

FIG. 8 illustrates a complete luminaire used in a lighting system illustrated in FIG. 1.

### DETAILED DESCRIPTION OF THE INVENTION

Preferred embodiments of the present invention are illustrated in the Figures, like numerals being used to refer to like and corresponding parts of the various drawings.

The present invention generally relates to a method for providing special effects in wash light luminaires, specifically to a method relating to providing controllable lighting effects from a luminaire with a wash light distribution with a large effective source and true blending output distribution.

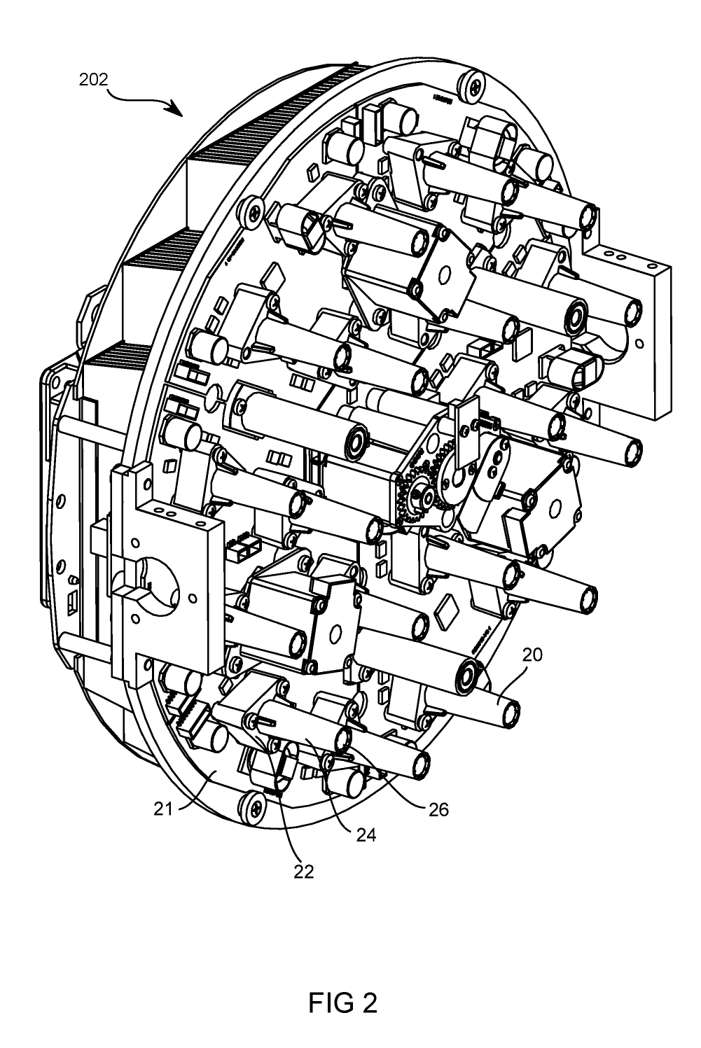

FIG. 2 illustrates the layout of an embodiment of the rear portion 202 of a light engine of a luminaire generating multiple beam effects. The light engine consists of a plurality of separate light modules 20. Each light module may comprise: light isolating cover or enclosure 22 containing light emitting component (such as an LED not shown) a protective sleeve 24, protecting a light guide optic (not shown) with an exit apperature 26. Light emitting component (not shown) dmay comprise a single LED or an array of LEDs, which may include a primary optic (not shown). Light emitting component may contain a single color of LEDs or may contain multiple dies, each of which may be of common or differing colors. For example, in one embodiment light emitting component may comprise one each of a Red, Green, Blue and White LED. In further embodiments light emitting component may comprise a single LED chip or package while in yet further embodiments Light emitting component may comprise multiple LED chips or packages either under a single primary optic or each package with its own primary optic. In some embodiments these LED die(s) may be paired with optical lens element(s) as part of the LED light-emitting module. In a further embodiment light emitting component may comprise more than four colors of LEDs. For example, seven colors may be used, one each of a Red, Green, Blue, White, Amber, Cyan, and Deep Blue/UV LED die.

The light output from the LEDs in light emitting component contained or covered by a light isolating enclosure 22 enters a light guide optic (not shown) contained within protective sleeve 24. Light guide optic may be a device utilizing internal reflection so as to collect, homogenize and constrain and conduct the light to exit port 26. Light guide optic may be a hollow tube with a reflective inner surface such that light impinging into the entry port may be reflected multiple times along the tube before leaving at the exit port 26. Light guide optic may be a square tube, a hexagonal tube, a heptagonal tube, an octagonal tube, a circular tube, or a tube of any other cross section. In a further embodiment light guide optic may be a solid rod constructed of glass, transparent plastic or other optically transparent material where the reflection of the incident light beam within the rod is due to “total internal reflection” (TIR) from the interface between the material of the rod and the surrounding air. The integrating rod may be a square rod, a hexagonal rod, a heptagonal rod, an octagonal rod, a circular rod, or a rod of any other cross section. Light guide optic, whether solid or hollow, and with any number of sides, may have an entry port adjacent to the light emitting component and exit port 26 that differ in cross sectional shape. For example, a square entry port and an octagonal exit port 26. Further light guide optic may have sides which are tapered so that the entrance aperture is smaller than the exit aperture. The advantage of such a structure is that the divergence angle of light exiting the light guide optic at exit port 26 will be smaller than the divergence angle for light entering the guide. The combination of a smaller divergence angle from a larger aperture serves to conserve the etendue of the system. Thus a tapered light guide optic may provide similar functionality to a condensing optical system.

Light isolating enclosure 22 along with protective sleeve 24 serve to prevent light spill from one light emitting component to any of the adjacent light emitting components.

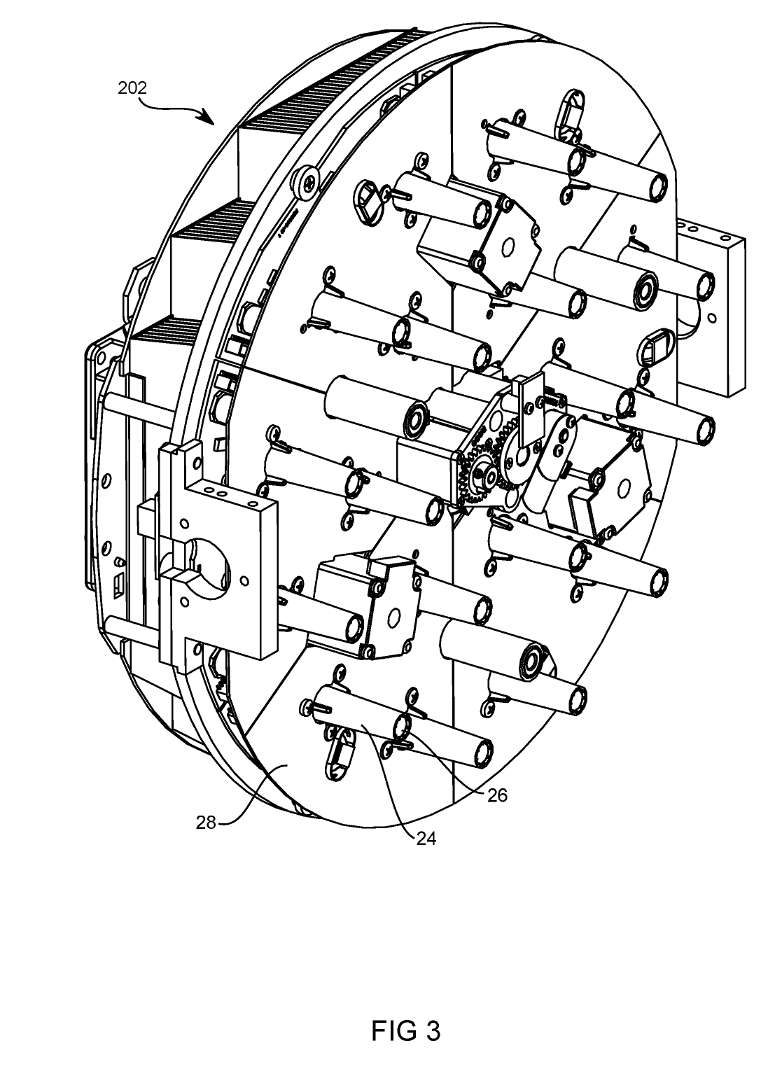

FIG. 3 illustrates an embodiment of the light engine illustrated in FIG. 2 fitted with a first light shield 28. The light seal around the light cover or isolating enclosure 22 in FIG. 2 may not be perfect and some light may escape around its edge. Accordingly, a first light shield 28 is added as an additional blocker for any stray or spill light. Light shield 28 may comprise a punched plate with apertures that fit snugly around protective sleeve 24. Light shield 28 may be painted black or treated with a nonreflective coating.

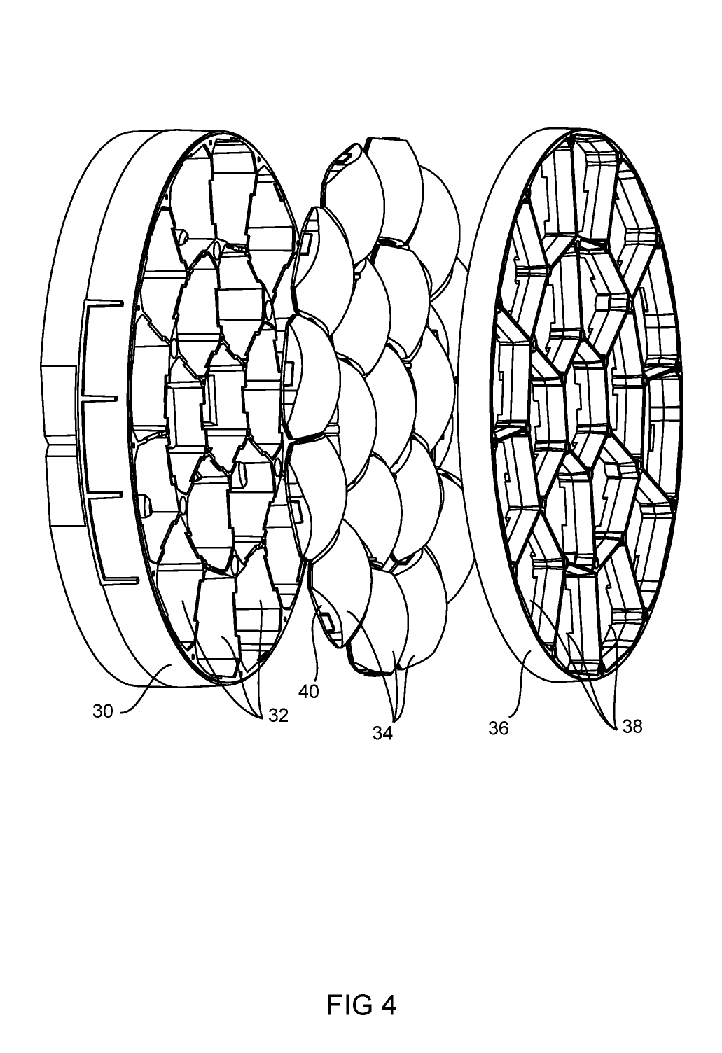

FIG. 4 illustrates an embodiment of a first baffle 30, lenses 34, and a second baffle 38 of the light output portion of a luminaire generating multiple beam effects. First baffle 30 comprises a plurality of separated and light shielded compartments 32; one compartment 32 for each LED module and its associated optics. The separate compartments 32 serve to further constrain light and prevent it spilling into adjacent modules. Lenses 34 are produced as separate lenses, rather than being molded from a single piece of glass or plastic, so as to maintain the individual light paths and prevent spill from one lens to an adjacent lens. After passing through lenses 34 the light passes through a second baffle 36 with light shielded compartments 38. First baffle 30 and second baffle 36 are advantageously manufactured or coated with a black or other anti-reflective coating. At this point each light module combined with the baffle compartments 32 and 38 and lens 34 paired with the light source enclosure and optics form a light engine module which together form an array of adjacent light engine modules or a light engine array.

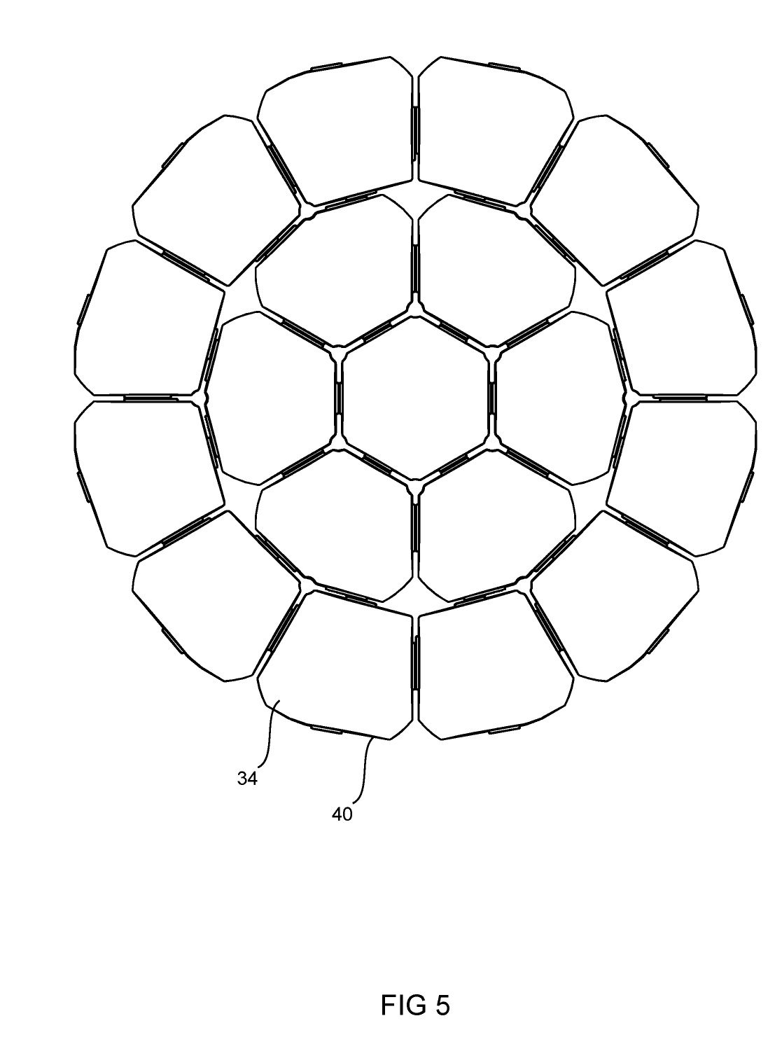

FIG. 5 illustrates a further view of an embodiment of lenses 34. Each lens 34 in the array is separated from its neighbors and may have its edges 40 painted, printed or otherwise coated with a black or other light absorbing coating. Treating the edges 40 of lenses 34 with a light absorbing coating prevents light that is internally reflected or refracted within lenses 34 from entering adjacent lenses as spill light. The system illustrated herein utilizes a single lens element as lens. The invention is however not so limited, and further embodiments may contain different numbers and types of lenses or other optical systems as well known in the art. In particular, further embodiments may utilize systems where lens 34 comprises multiple elements. In further embodiments lens 34 may comprise a number of optical lens elements whose relationship to each other is not fixed, and can alter. The elements of lens 34 may be meniscus lenses, plano convex lenses, bi-convex lenses, holographic lenses, aspheric lenses, or other lenses as well known in the art. The elements of lens 34 may be constructed of glass, transparent plastic or other optically transparent material as known in the art.

In a preferred embodiment lens 34 comprises a single element constructed, by the use of aspheric surfaces or otherwise, to exhibit achromatic properties such that the colors in the light beam remain homogenized and do not produce objectionable colored fringing to the light beam.

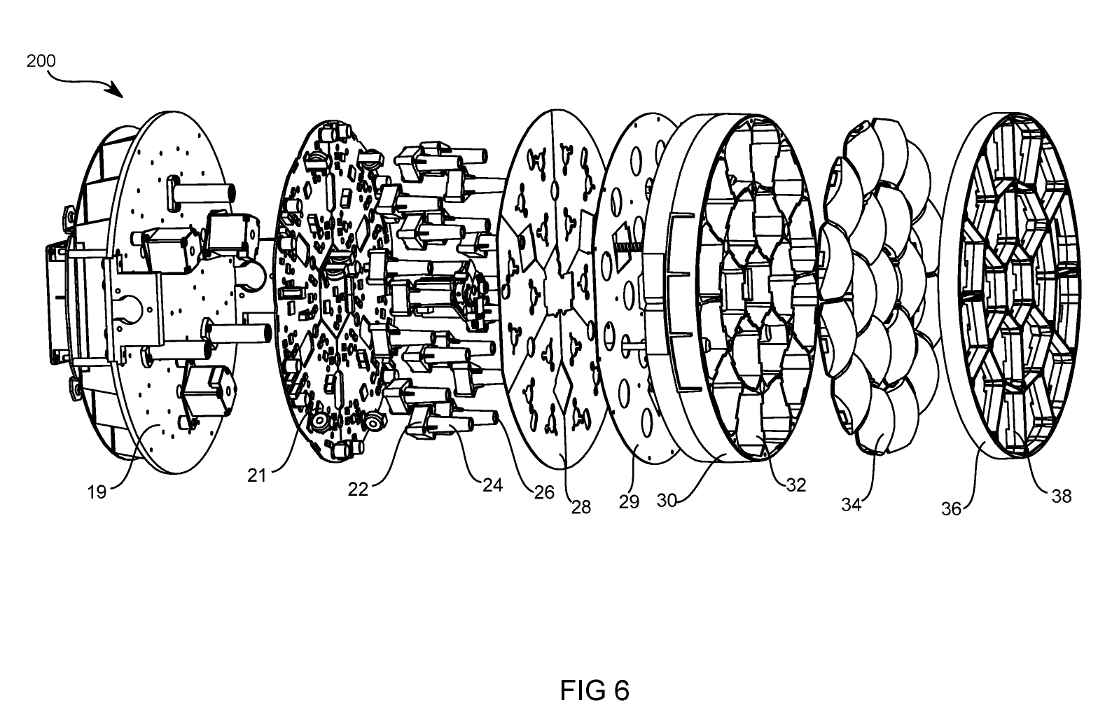

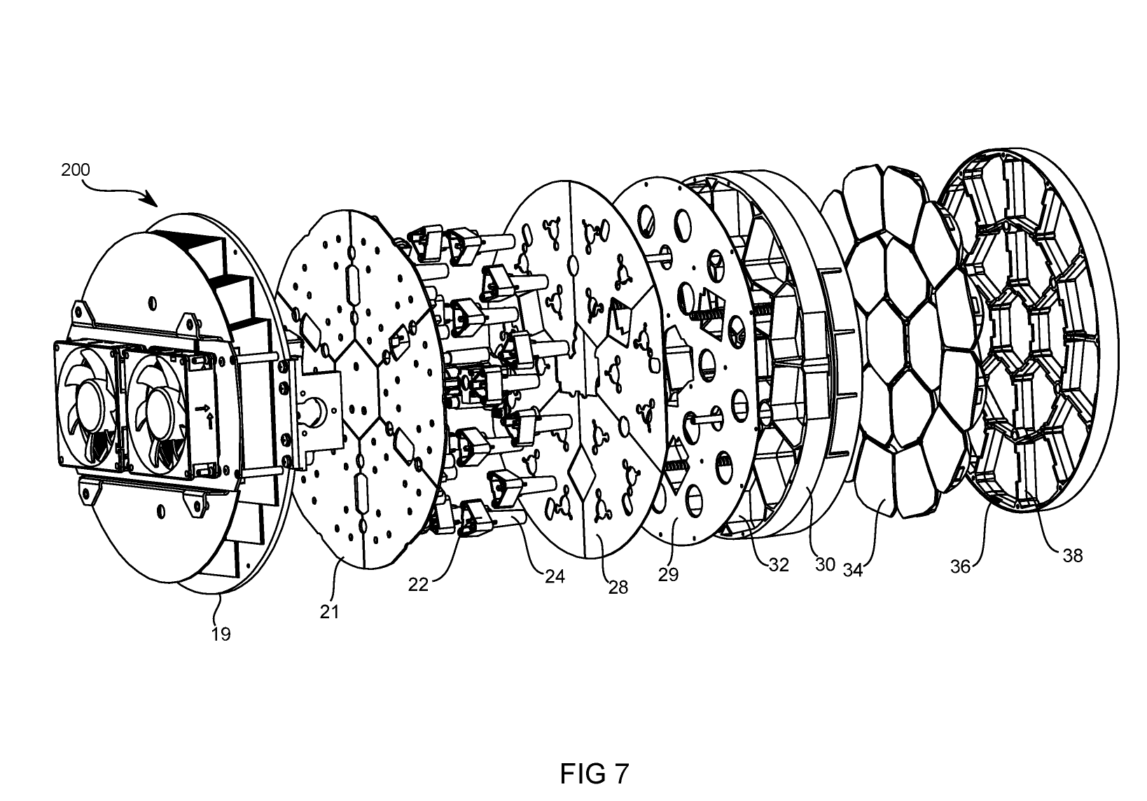

FIGS. 6 and 7 illustrate exploded views of the light engine array 200 with light spill prevention system of an embodiment of a luminaire generating multiple beam effects. The differ in that FIG. 6 illustrates a slightly front angled view into the light beam and FIG. 7 illustrates a slightly rear angled view along the light beam. The figures illustrate a back supporting structure 19. First mounted to the support structure is a PCB board(s) 21 to which the light sources (not called out) are mounted. Next are the source covers 22 with light shields 24 with exit aperatures 26. Next comes the first light shield 28 which will nest down low near the base of the light shields 24. These figures also illustrate a second light shield 29 which may be fitted on the rear of first baffle 30. This second light shield 29 prevents light that may be reflected back from a lens 34 into a compartment 32 from further reflecting from first light shield 28 and spilling into adjacent compartments. An embodiment of a complete spill light prevention system may comprise; light isolating enclosure 22 along with protective sleeve 24, first light shield 28, second light shield 29, first baffle 30 with individual compartments 32, edge coated lenses 34, and second baffle 36 with individual compartments 38. The overall result is that the individual light engine modules are maintained as individual and separate beams such that each light module engine in the light engine array is distinct and separate to the viewer.

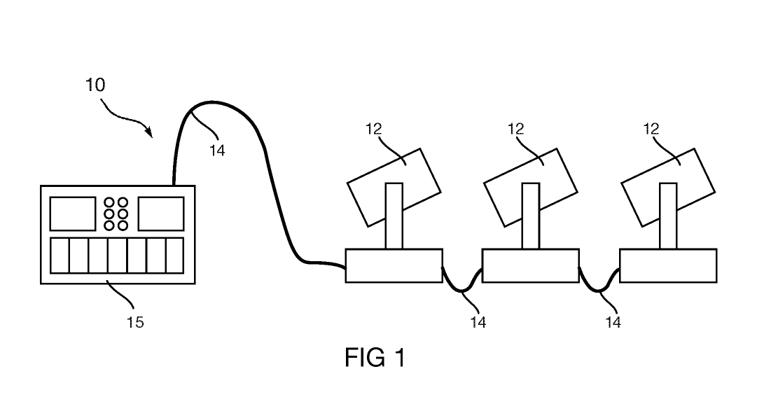

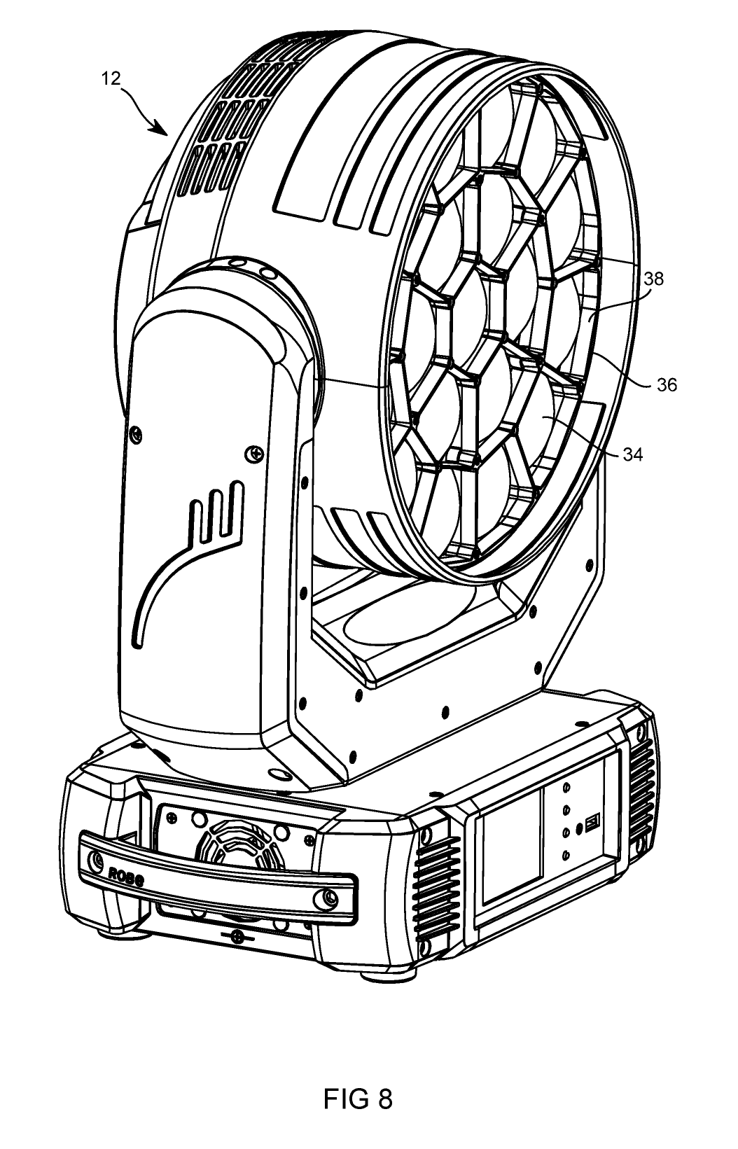

FIG. 8 illustrates a complete luminaire as may be used in a lighting system such as that illustrated in FIG. 1. Lenses 34 are visible along with second baffle 36 and compartments 38.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. A luminaire comprised of a plurality of light engine modules where the light engine modules are compartmentalized from light spill from adjacent modules via:
a. a light enclosure around each light modules light source;
b. a first light shield that protects the light engine module from light spill off of the PCB board into the rest of the light engine module;
c. a second light shield which prevents light from entering compartments formed by—
d. a first baffle forming shielding compartment(s) before the output lens;
e. a second baffled forming shielding compartment(s) after the output lens; and
f. light shielding edge treatments on the lens(s) to prevent light spill between lenses.

2. The luminaire of claim 1 where one or more of the light shields or baffles are surfaced with nonreflective material.

3. The luminaire of claim 1 where all of the light shields or baffles are surfaced with nonreflective material.

4. The luminaire of claim 1 where one or more of the light shields or baffles are include heat conducting material

5. The luminaire of claim 1 where the first light shield includes heat conducting material.

6. The luminaire of claim 1 where one or more of the light shields or baffles are plastic

7. The luminaire of claim 1 where all of the light shields or baffles are plastic
